(19) United States
(12) Patent Application Publication
(10) Pub. No.: US 2026/0109173 A1
(43) Pub. Date: Apr. 23, 2026

(54) SELF-LEVELING PAINT CADDY

(71) Applicant: Painter's Pocket LLC, West Hartford, CT (US)

(72) Inventor: John Dussault, Wethersfield, CT (US)

(73) Assignee: Painter's Pocket LLC, West Hartford, CT (US)

(21) Appl. No.: 19/321,928

(22) Filed: Sep. 8, 2025

Related U.S. Application Data
(60) Provisional application No. 63/699,488, filed on Sep. 26, 2024.

(51) Int. Cl. B44D 3/12; A45F 5/02; B33Y 80/00

(52) U.S. Cl. CPC B44D 3/123; A45F 5/021; B33Y 80/00; B44D 3/126

(57) ABSTRACT

A self-leveling paint caddy including interchangeable paint containers. The paint container is operable to swing freely around a clip, wherein the clip attaches to the belt of a user. The modular design of the self-leveling paint caddy provides for users to conveniently carry and manage paints directly from their belts. Furthermore, the self-leveling attachment mechanism of the invention provides for spill prevention as the user moves around a workspace.

### CROSS REFERENCES TO RELATED APPLICATIONS

This application claims priority to and the benefit of U.S. Provisional Application No. 63/699,488, filed Sep. 26, 2024, which is incorporated herein by reference in its entirety.

### BACKGROUND OF THE INVENTION

### 1. Field of the Invention

The present invention relates to a paint caddy, and more specifically to a self-leveling paint caddy including interchangeable paint containers.

### 2. Description of the Prior Art

It is generally known in the prior art to provide wearable painter assistant device, such as painter's belt.

Prior art patent documents include the following:

U.S. Pat. No. 2,908,468 for Container support by inventor Thomas, filed Oct. 5, 1953 and issued Oct. 13, 1959, is directed to paint pans and particularly paint pans especially suited to use of roller painters. An object is to so install a friction-inducing screen or the like within an open-topped paint pan and against a wall of such pan that a painting roller may be lightly pressed against such screen during withdrawal from the pan, assuring a desired rotation of the roller.

U.S. Pat. No. 6,866,172 for Painter's belt-mounted paint and applicator holder by inventor Shackelford, filed Apr. 1, 2003 and issued Mar. 15, 2005, is directed to a painter's belt-mounted paint and brush holder especially adapted for stability relative to the painter. It includes an open topped bucket with a rim that drains into the bucket cavity, and a stabilizer integral with the wall of the bucket that rises above the bucket with a substantial area that is drawn against the body of the painter.

U.S. Pat. No. 11,345,186 for Tool container by inventor Franklin, filed Feb. 24, 2020 and issued May 31, 2022, is directed to a system for a tool container including a container assembly and a mounting system assembly. The container assembly includes a container that includes a magnetic band along an interior perimeter for attaching tools thereto. The container further includes a handle for ease of transporting the container. Importantly, mounted to the container is the mounting system assembly which includes a hook attached to the handle of the container at one end. The opposite end of the hook is attached to the user, preferably, to a belt of the user. Further, the mounting system assembly includes a strap that is mounted around the leg of the user. The strap is secured with hook and loop fasteners to adjust the strap around the user tightly. The user can carry all materials with the container and keep it secured in place with the mounting system assembly.

U.S. Pat. No. 2,095,351 for Painter's equipment by inventor Van Winkle, filed Jun. 11, 1936 and issued Oct. 12, 1937, is directed to painter's equipment and particularly to such as may be used by painters engaged commercially in the painting trade. An object of the invention is to provide an arrangement of means whereby a painter may save considerable time and effort on painting jobs.

U.S. Pat. No. 5,489,051 for Painter's pouch by inventor Robinson, filed Sep. 22, 1993 and issued Feb. 6, 1996, is directed to a gravity responsive apparatus for the carriage of paint and paint application related tools suspended upon the hip of a painter which consists of a hip-supported, belt-attached base member which is flexibly attached by means of a separable ball and socket joint to a freely swinging sealable paint container and fitted tool carrier. Use of the device allows a painter to easily and safely scale ladders and scaffolds without danger of paint spillage and upon arrival at the place of application of paint to simply flip open and fold back the hinged, gasketed cover for access to the paint supply. A variety of painters preparation and application tools may be carried in the integral tool rack which is a part of the apparatus. The freely swinging construction allows the painter to assume almost any position without the probability of paint spillage or tool droppage and being fabricated of a smooth, seamless material, is readily cleanable and requires little care or maintenance.

US Patent Pub. No. 2017/0015133 for Paint Holster with Reservoir by inventor Lopez, filed Jul. 16, 2015 and published Jan. 19, 2017, is directed to a manual paint system comprising a holster with cooperatively formed paint reservoir that fixates to the painter's person. The holster is in fluid communication via a valve with a reservoir that holds fresh clean paint. The holster receives a regulated flow of paint when the valve is open. The holster includes a fixator for securing the applicator so that the handle is available for easy grasp while the brush bristles or roller remain wet in paint within the holster. Scrapers within the holster remove excess paint from the applicator and are configured to return the excess paint to the holster for later use. The fixator may be attached to a gate that slideably opens and closes the valve, thereby allowing the painter to load the holster with paint by simply pulling out the applicator and shut off the flow by pushing the applicator back into the holster.

U.S. Pat. No. 12,262,807 for Belt mounted paint and brush holder apparatus by inventor Copp, filed Jul. 12, 2022 and issued Jan. 18, 2024, is directed to a belt mounted paint and applicator holder apparatus adapted for stability and convenience comprising of a bucket portion, a top portion being nestable on the bucket portion upper open end, a pair of opposing toggle latches to cooperate with corresponding toggle latches on the bucket outer surface to form a clasped position wherein the bucket and top portion are nestled together, a buckle belt coupler having a pair of first vertical slots for insertion of a belt therethrough, and a quick-connect self-leveling coupling mechanism between the top and bucket portion, when in the clasped position, to maintain stability and self-leveling.

U.S. Pat. No. 3,997,092 for Paint container carrier by inventor Pogwizd, filed Nov. 18, 1974 and issued Dec. 14, 1976, is directed to an improved paint container carrier for holding a container of paint having a contoured shape to conform to the contour of the user's body.

The container further as a pivotally mounted lid for preventing spills and contamination of paint and straps for securing the device to the user's body. An adapter sleeve is provided so that the paint container carrier may receive various sizes of paint containers.

U.S. Pat. No. 8,887,940 for Portable paint and tool container by inventors Kiceniuk Jr. et al., filed Jun. 30, 2011 and issued Nov. 18, 2014, is directed to a container provided for carrying a quantity of paint and a plurality of tools; a flange element is comprised having a variety of holes, recesses and magnets to receive tools and supplies; the container optionally comprising a bail type handle, sealing lid and carrying strap.

US Patent Pub. No. 2003/0089748 for Portable container for paint, roller and brush by inventors Whalen, et al., filed Nov. 9, 2001 and published May 15, 2003, is directed to a portable device for carrying a paint roller and paint in a hands-free fashion. The device includes a main storage compartment in which paint is stored. This main compartment is sized so that a paint roller can be placed therein and the compartment further includes an element such as a clip for holding the paint roller within the storage compartment. When the roller is stored in this fashion, it is elevated above the upper surface of the paint in the storage compartment. If desired, an additional storage compartment can be included which compartment allows for the storage of a paint brush. The device is connected to the painter by a belt clip or by a shoulder strap.

U.S. Pat. No. 10,420,414 for Self-righting container caddy by inventors Snyder, et al., filed Jan. 8, 2018 and issued Sep. 24, 2019, is directed to a belt and neck holder for a container such as a can of paint which offsets the container from the wearer via a double axis gimbal mechanism to provide free axial rotation of the secured container to prevent spillage. The holder is detachable from the belt and neck and provided in different sizes to hold standard containers such as a gallon can of paint.

U.S. Pat. No. 10,046,595 for Hands-free paint holder by inventor Reynolds, filed Jul. 13, 2017 and issued Aug. 14, 2018, is directed to a hands-free, belt-worn paint container support apparatus including a receptacle for holding a paint container, a handle rotatably connected to the receptacle, one or more spacers rotatably connected to the handle, a belt tab connected to the spacers, and first and second spaced panels operationally connected to the spacers, where each panel is connected to the spacers, where the handle is rotatably connected to the first side panel, and where the belt tab is connected to the second side panel. In additional embodiments, the belt may be configured to accommodate paint trays as well as paint holders.

U.S. Pat. No. 8,783,538 for Bucket and tool holder by inventor Dattilo, filed Apr. 10, 2012 and issued Jul. 22, 2014, is directed to a work mans belt-mounted holder which allows a container to be suspended from the waist of a work man freeing up his hands. The holder has a belt receiving member of flexible material with slots to securely hold the belt receiving member on a belt. The holder is fixedly attached to belt receiving member and projects from the receiving member to hold a container. Built into the holder are openings for hand tools to be placed for easy access when needed.

U.S. Pat. No. 4,433,801 for Painter's caddy by inventor Swinney, filed Apr. 2, 1982 and issued Feb. 28, 1984, is directed to a rack or holder for a paint bucket is linked to a belt-held member in a manner to permit movement about three axes all at right angles to one another so that the bucket is maintained in an upright position.

US Patent Pub. No. 2024/0174021 for Attachable Paintbrush Holder Device by inventor Arsate, filed Sep. 19, 2023 and published May 30, 2024, is directed to an attachable paintbrush holder device. The device is comprised of a back plate and at least one side wall that forms an interior space with the back plate. The device is intended to allow a user to store a paintbrush on their person via their belt by attaching a belt through the back plate via two openings in the back plate or a fastener. Then, a user can place a paintbrush into the interior space when not in use.

U.S. Pat. No. 10,836,206 for Paint bucket for holding paint and paint accessories by inventor Keane, filed Mar. 27, 2019 and issued Nov. 17, 2020, is directed to a paint bucket including a housing having a trough defined therein for holding paint and/or paint accessories. The housing includes a pair of apertures defined in a back panel thereof that extend therethrough. Each aperture is disposed proximate an opposing side of the housing. A band is adapted to engage between belt loops on a pair of pants. A pair of selectively engageable loops is each configured to engage both a corresponding aperture defined in the back panel of the housing and the band to secure the paint bucket thereto such that the paint bucket remains upright as a painter navigates a ladder or a sloped terrain.

U.S. Pat. No. 6,283,345 for Paint container system by inventor Butschat, filed Sep. 28, 1999 and issued Sep. 4, 2001, is directed to a paint container system for attachment to a person that maintains a substantially vertical position regardless of the position of the person. The inventive device includes a tubular belt adapter for removably attaching to a conventional hip belt, a shaft having a flanged end extending from the belt adapter, a container having a receiver aperture within an upper portion for removably receiving the shaft, and a bracket having a pair of resilient clips attached thereto for attaching within the container. The container preferably has four side walls, a floor and an upper open end. An extended portion from the container includes the receiver aperture for receiving the shaft of the belt adapter. The container swivels upon the shaft of the belt adapter during use thereby maintaining the container in a substantially vertical position at all times regardless of the position of the user. The bracket for supporting a paintbrush is positionable about the upper rim of the container in any desired located.

### SUMMARY OF THE INVENTION

The present invention relates to a paint caddy, and more specifically to a self-leveling paint caddy including interchangeable paint containers.

It is an object of this invention to provide a tool that assists painters to carry and manage paint as they work.

In one embodiment, the present invention includes a self-leveling paint caddy, comprising a container including a substantially flat back and a pocket, a clip, and an attachment post integrally formed with the container, wherein the pocket extends from a bottom end of a front side of the substantially flat back, and wherein the pocket includes a top opening, wherein an interior side wall of the pocket includes a textured surface, wherein the pocket includes a magnetic element, and wherein the magnetic element is operable to hold a magnetized painting tool in place, wherein the substantially flat back wall includes a hook, and wherein the attachment post is configured to receive the clip, and wherein the container is operable to rotate about the clip.

In another embodiment, the present invention includes a self-leveling paint caddy, comprising a container including a substantially flat back and a pocket, a clip, and an attachment post integrally formed with the container, wherein the pocket extends from a bottom end of a front side of the substantially flat back, and wherein the pocket includes a top opening, wherein a front wall of the pocket includes a top extension, wherein the top extension includes a magnetic element, and wherein the magnetic element is not visible externally, wherein the substantially flat back wall includes a hook, wherein the attachment post is configured to receive the clip, and wherein the container is operable to rotate about the clip, and wherein the clip includes three prongs, wherein one of the three prongs terminates in a bend.

In yet another embodiment, the present invention includes a system for automatic leveling paint storage, comprising a container and a clip, wherein the container includes an attachment post, wherein the clip is configured to attach to a belt and receives the container, wherein the container fastens to the clip via the attachment post, wherein the clip includes an enclosed opening, wherein the container is operable to rotate about the clip, and wherein the clip is configured to receive a replacement container.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a perspective side exploded view of a paint caddy according to one embodiment of the present invention.

FIG. 2 illustrates a perspective side view of a paint container according to another embodiment of the present invention.

FIG. 3 illustrates a perspective exploded view of a paint caddy according to one embodiment of the present invention.

FIG. 4 illustrates a perspective view of a paint container according to another embodiment of the present invention.

FIG. 5 illustrates a top exploded view of a paint caddy according to one embodiment of the present invention.

FIG. 6 illustrates a top view of a paint container according to another embodiment of the present invention.

FIG. 7 illustrates a perspective top exploded view of a paint caddy with a paint roller according to one embodiment of the present invention.

FIG. 8 illustrates a perspective side view of the clip according to one embodiment of the present invention.

### DETAILED DESCRIPTION

The present invention is generally directed to a paint caddy, and more specifically to a self-leveling paint caddy including interchangeable paint containers.

In one embodiment, the present invention includes a self-leveling paint caddy, comprising a container including a substantially flat back and a pocket, a clip, and an attachment post integrally formed with the container, wherein the pocket extends from a bottom end of a front side of the substantially flat back, and wherein the pocket includes a top opening, wherein an interior side of the pocket includes a textured surface, wherein the pocket includes a magnetic element, and wherein the magnetic element is operable to hold a magnetized painting tool in place, wherein the substantially flat back wall includes a hook, and wherein the attachment post is configured to receive the clip, and wherein the container is operable to rotate about the clip. In one embodiment, the pocket is operable to hold about 1.5 quarts of paint. In one embodiment, the container is formed from additive manufacturing techniques. In one embodiment, the textured surface includes ridges integrally formed with the container. In one embodiment, the textured surface is created as a separate component, wherein the textured surface is operable to be attached to the container, wherein the textured surface includes a plurality of raised ridges. In one embodiment, the container further includes a disposable liner. In one embodiment, the clip is operable to hold about 12 pounds of weight.

In another embodiment, the present invention includes a self-leveling paint caddy, comprising a container including a substantially flat back and a pocket, a clip, and an attachment post integrally formed with the container, wherein the pocket extends from a bottom end of a front side of the substantially flat back, and wherein the pocket includes a top opening, wherein a front wall of the pocket includes a top extension, wherein the top extension includes a magnetic element, and wherein the magnetic element is not visible externally, wherein the substantially flat back wall includes a hook, wherein the attachment post is configured to receive the clip, and wherein the container is operable to rotate about the clip, and wherein the clip includes three prongs, wherein one of the three prongs terminates in a bend. In one embodiment, the clip is formed from additive manufacturing techniques. In one embodiment, the hook is configured to hold a painting tool in a resting position, wherein the hook is operable to be switched out with a replacement hook, and wherein the replacement hook is a different size and/or shape from the hook. In one embodiment, at least one surface of the container is coated, wherein the coating is operable to prevent the paint from adhering to the at least one surface. In one embodiment, the top extension includes a plurality of recesses, wherein the plurality of recesses are evenly distributed across the top extension. In one embodiment, an outer prong of the clip includes an opening for the attachment post.

In yet another embodiment, the present invention includes a system for automatic leveling paint storage, comprising a container and a clip, wherein the container includes an attachment post, wherein the clip is configured to attach to a belt and receives the container, wherein the container fastens to the clip via the attachment post, wherein the clip includes an enclosed opening, wherein the container is operable to rotate about the clip, and wherein the clip is configured to receive a replacement container. In one embodiment, the container is operable to hold about 1.5 quarts of paint. In one embodiment, the clip includes three prongs, wherein one of the three prongs terminates in a bend. In one embodiment, the container further includes a disposable liner.

Painting is labor-intensive work, riddled with safety hazards. For jobs that require painting large stretches of space, painters need to either hold a paint container as they work, occupying one hand, or constantly reposition the paint container down as they complete an area. These tactics introduce muscle strain and can result in reduced productivity.

Furthermore, should the work require use of a ladder, the painter faces safety concerns. Climbing up and down the ladder with equipment will typically result in one hand being occupied, amplifying the risk of falling. The present invention addresses this concern by attaching the paint caddy to the painter's belt, so that the painter is free to use both hands. Additionally, working on a ladder limits the options available for where to position the paint container. If the painter sets the paint container on the ladder, the risk of tipping the container over and adding additional clean-up time increases. There exists prior art which describes paint containers that a painter is able to wear or clip onto his belt; however, none of the references incorporate a modular design using interchangeable containers, wherein a painter is able to quickly swap to another paint color or type without having to clean out the paint container.

While competitor devices exist in the market, many face complaints of being too bulky and/or impractical. The present invention provides a streamlined design, factoring in ergonomic support. Additionally with its attachment mechanism design, the present invention provides a solution to prevent spills as a painter moves about.

None of the prior art discloses a compact, self-leveling paint caddy with interchangeable paint containers to easily clip onto a painter's belt.

Referring now to the drawings in general, the illustrations are for the purpose of describing one or more preferred embodiments of the invention and are not intended to limit the invention thereto.

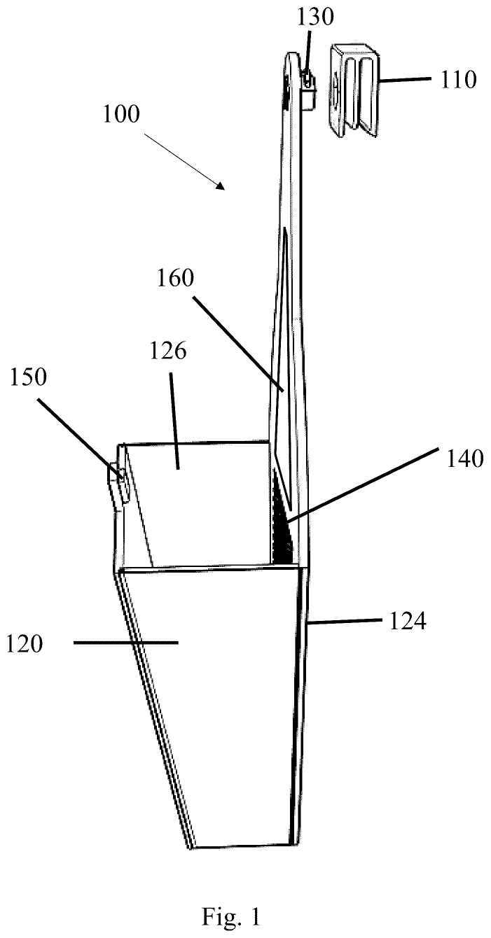

FIG. 1 illustrates a perspective side exploded view of the paint caddy. In one embodiment, the paint caddy 100 is comprised of three main components, the clip 110, the paint container 120, and the attachment post 130, wherein the paint container 120 is connected to the clip 110 by the attachment post 130. The clip 110 is operable to attach to a user's belt, providing a lightweight yet robust structure to hold a paint container 120 as the user moves around to paint. The paint container 120 includes a substantially flat back 124 and a pocket 126, wherein the pocket 126 extends from a bottom end of a front side of the back wall 124 and is open to a top. In one embodiment, the pocket 126 is the receptacle operable to be filled with paint. In one embodiment, the pocket 126, when viewed from the side, has a substantially trapezoidal cross-section. However, the present disclosure is not limited thereto. In one embodiment, the bottom half of the back wall 124 is shaped substantially a trapezoid. However, the present disclosure is not limited thereto. In one embodiment, the back wall 124 narrows to a bottom end. In one embodiment, the back wall 124 narrows to a top end. In one embodiment, when viewed from the back, the cross-section of the back wall 124 is a composite shape, wherein the composite shape has a substantially wider midsection than the top end or bottom end.

In one embodiment, the paint caddy 100 is comprised of one or more materials, including but not limited to one or more plastics, one or more metals, fiber reinforced composites, rubber, and/or fabrics. In one embodiment, the material used for the paint caddy 100 is a flexible plastic material, such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, and any combination thereof. In one embodiment, the material used for the paint caddy 100 is conducive for additive manufacturing, including but not limited to acrylonitrile butadiene styrene (ABS), polylactic acid (PLA), polyethylene terephthalate (PET), glycol-modified PET (PETG), nylon, stainless steel, and a combination of various blends. One of ordinary skill in the art can select the material for a high strength-to-weight ratio. In one embodiment, at least one component of the paint caddy 100 is coated, wherein the coating is operable to prevent paint from adhering to the at least one component. In one embodiment, the coating is operable to provide additional protection from the elements and from wear and tear. In one embodiment, the coating is a polymeric coating, including but not limited to resin-based coatings, acrylic-based coatings, and/or vinyl-based coatings, or a combination thereof.

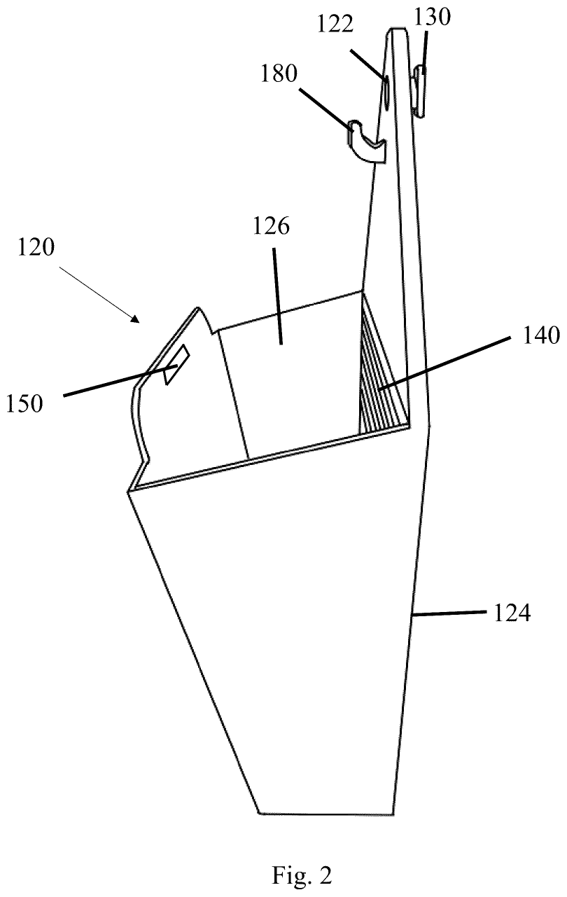

FIG. 2 illustrates a perspective side view of a paint container according to another embodiment of the present invention. In one embodiment, the paint container 120 includes a hook 180, wherein the hook 180 is operable to hold a paint roller in a resting position. In one embodiment, the handle of the paint roller includes a hole, wherein the hook 180 is operable to pass through the hole. In an alternative embodiment, the handle of the paint roller includes a section operable to rest on the hook 180. In one embodiment, the front side of the back wall 124 includes a hook 180. In one embodiment, the hook 180 is integrally formed with the paint container 120. In one embodiment, the paint container 120, hook 180, and attachment post 130 form a unitary body. In one embodiment, the hook 120 is operable to detach from the back wall 124, wherein the hook 120 is operable to be switched out with a replacement hook. In one embodiment, the replacement hook varies in size and/or shape from the original hook 180, in order to support a different style of paint roller handles.

In one embodiment, the hook 180 is comprised of one or more materials, including but not limited to one or more plastics, one or more metals, and/or one or more fiber-reinforced composites. In one embodiment, the hook 180 is comprised of a flexible plastic material, such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, and any combination thereof. In one embodiment, the material used for the hook 180 is conducive for additive manufacturing, including but not limited to acrylonitrile butadiene styrene (ABS), polylactic acid (PLA), polyethylene terephthalate (PET), glycol-modified PET (PETG), nylon, stainless steel, and a combination of various blends. One of ordinary skill in the art can select the material for a high strength-to-weight ratio. In one embodiment, the hook 180 is coated, wherein the coating is operable to prevent paint from adhering to the at least one component. In one embodiment, the coating is operable to provide additional protection from the elements and from wear and tear. In one embodiment, the coating is a polymeric coating, including but not limited to resin-based coatings, acrylic-based coatings, and/or vinyl-based coatings, or a combination thereof.

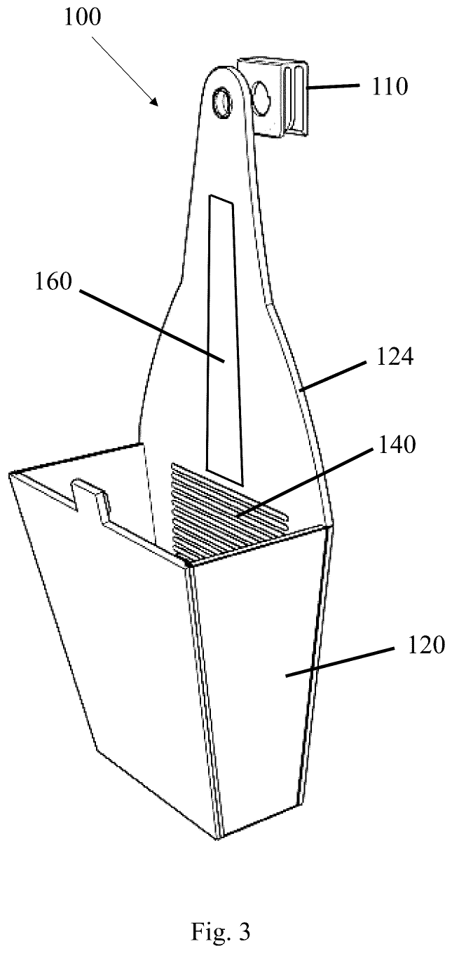

FIG. 3 illustrates a perspective exploded view of the paint caddy. In one embodiment, the paint caddy 100 is operable to switch out a paint container 120 with a different one, selected for size, shape, or content. Designed with modular components, the paint caddy 100 facilitates the convenient switching of paint color or types without the user needing to have cumbersome buckets on hand. In one embodiment, the paint container 120 comprises of a substantially flat side 124, wherein the substantially flat surface rests against the user's body. In one embodiment, the profile of the paint container 120 when viewed from the top is a slim profile, wherein the paint container 120 is close to the user's body to be easily accessible. In one embodiment, the paint container 120 is operable to hold up to about 1 pint of paint. In one embodiment, the paint container 120 is operable to hold up to about 1 quart of paint. In one embodiment, the paint container 120 is operable to hold up to about 1.5 quarts of paint. In one embodiment, the paint container 120 is operable to hold up to about 0.5 gallons of paint. In one embodiment, the paint container 120 is operable to hold up to about 1 gallon of paint. In one embodiment, the paint container 120 is operable to hold up to about 5 gallons of paint. In one embodiment, the paint container 120 is formed from additive manufacturing, including but not limited to fused deposition modeling (FDM), stereolithography (SLA), digital light processing (DLP), selective laser sintering (SLS), selective laser melting (SLM). Alternatively, the paint container 120 is formed from a different manufacturing process, including but not limited to injection molding, casting, computer numerical control (CNC) machining, or a combination. In one embodiment, the paint container 120 is formed from a combination of additive manufacturing techniques and subtractive manufacturing techniques.

In one embodiment, the paint container 120 is comprised of one or more materials, including but not limited to one or more plastics, one or more metals, fiber reinforced composites, rubber, and/or fabrics. In one embodiment, the material used for the paint container 120 is a flexible plastic material, such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, and any combination thereof. In one embodiment, the material used for the paint container 120 is conducive for additive manufacturing, including but not limited to acrylonitrile butadiene styrene (ABS), polylactic acid (PLA), polyethylene terephthalate (PET), glycol-modified PET (PETG), nylon, stainless steel, and a combination of various blends. One of ordinary skill in the art can select the material for a high strength-to-weight ratio. In one embodiment, at least one surface of the paint container 120 is coated, wherein the coating is operable to prevent the paint from adhering to the at least one surface. In one embodiment, the coating is operable to provide additional protection from the elements and from wear and tear. In one embodiment, the coating is a polymeric coating, including but not limited to resin-based coatings, acrylic-based coatings, and/or vinyl-based coatings, or a combination thereof.

In one embodiment, the interior of the paint container 120 includes a textured surface 140, wherein excess paint on a painting tool is deposited. In one embodiment, the textured surface 140 is comprised of a plurality of raised ridges. In one embodiment, the textured surface 140 is located on one interior side of the paint container 120. In another embodiment, the interior surface of the paint container 120 is flat, without a textured surface 140. In one embodiment, the textured surface 140 is integrally formed with the paint container 120. In one embodiment, the textured surface 140 is created as a separate component and attached to the paint container 120, wherein the textured surface 140 is operable to be removable and replaced.

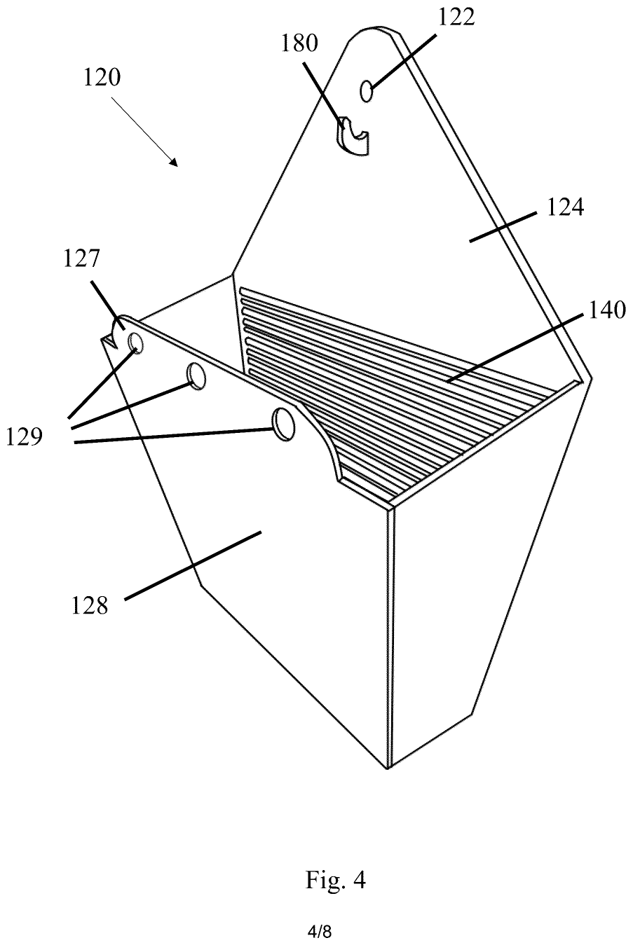

FIG. 4 illustrates a perspective view of a paint container according to another embodiment of the present invention. In one embodiment, the front wall 128 of the paint container 120 includes a top extension 127. In one embodiment, the maximum length of top extension 127 is smaller than the maximum length of the front wall 128. In one embodiment, the length of the base of the top extension 127 is the same as the maximum length of the front wall 128, wherein there is no visible boundary between the front wall 128 and top extension 127. In one embodiment, the paint container 120 includes recesses 129, wherein the recesses 129 are located in the top extension 127. In one embodiment, the recesses 129 are on the front surface of the front wall 128. In one embodiment, the paint container 120 includes at least one recess. In one embodiment, the recesses 129 are distributed evenly across the top extension 127. In one embodiment, the recesses 129 are distributed asymmetrically across the top extension 127. In one embodiment, the recesses 129 are distributed symmetrically across the top extension 127. In one embodiment, the paint container 120 includes at least one recess 129 to reduce the weight of the paint container 120 by removing material from non-load bearing sections. In one embodiment, at least one recess 129 has a substantially ellipse shape. In one embodiment, at least one recess 129 is operable to comprise any shape. In one embodiment, the paint container 120 comprises the recesses 129 for balancing the paint container 120. In one embodiment, at least one recess 129 is operable to contain a front magnet 150, wherein the front magnet 150 is flush with the front surface of the front wall. The front magnet 150 provides for a magnetized painting tool placed within, or adjacent to, the pocket to be held in place. One of ordinary skill will appreciate the shape of the at least one recess 129 is operable to match the shape of the front magnet 150. In one embodiment, the front magnet 150 is operable to hold an unused magnetized painting tool on the outside of the paint container 120.

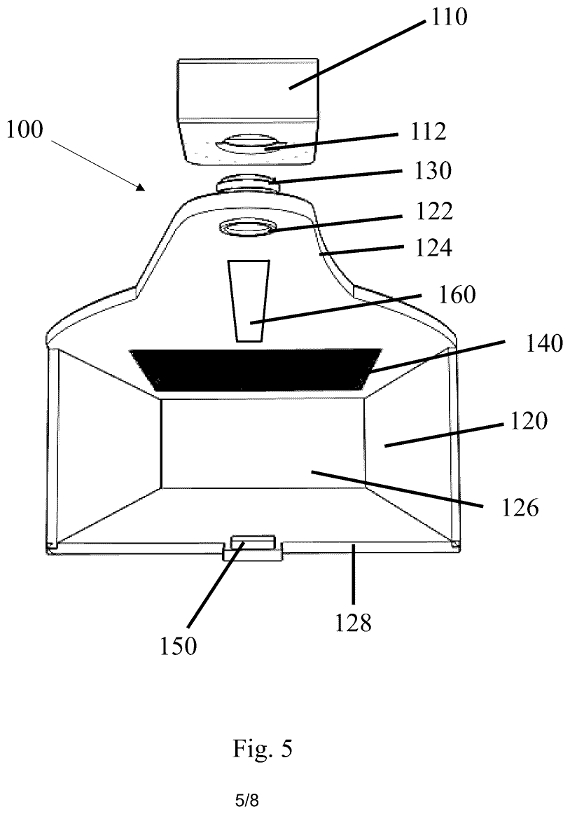

FIG. 5 illustrates a perspective top exploded view of the paint caddy. In one embodiment, the attachment post 130 is integrally formed with the paint container 120. In one embodiment, the attachment post 130 is hollow, wherein the attachment post 130 includes a through hole. In one embodiment, the attachment post 130 is press-fit into the receiving opening 122 of the paint container 120. This press-fit design enhances the structural integrity of the connection, providing a stable and reliable linkage between the clip 110 and the paint container 120. In one embodiment, the attachment post 130 is press-fit into the opening 112 of the clip 110. In one embodiment, the paint container 120 is connected to the clip 110 with a snap-fit joint. This snap-fit design facilitates switching paint containers without the need for additional tools (e.g., screwdrivers) and/or hardware (e.g., nuts, washers, screws). In one embodiment, the attachment post 130 is connected to the clip 110 with a snap-fit joint. In one embodiment, the attachment post 130 is connected to the paint container 120 with a snap-fit joint. In one embodiment, the paint container 120 and the clip 110 are connected via a clearance fit. In one embodiment, the paint container 120 is connected to the clip 110 with a fastener, wherein the paint container 120 is operable to freely rotate around the fastener. One of ordinary skill in the art will appreciate the clip 110 is operable to connect to the paint container 120 in any combination known such that the paint container 120 is operable to rotate. The rotation of the paint container 120 due to gravity acts as a self-leveling mechanism, preventing the paint container 120 from spilling.

In one embodiment, the attachment post 130 is comprised of one or more materials, including but not limited to one or more plastics, one or more metals, and/or one or more fiber-reinforced composites. In one embodiment, the material used for the attachment post 130 is a flexible plastic material, such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, and any combination thereof. In one embodiment, the material used for the attachment post 130 is conducive for additive manufacturing, including but not limited to acrylonitrile butadiene styrene (ABS), polylactic acid (PLA), polyethylene terephthalate (PET), glycol-modified PET (PETG), nylon, stainless steel, and a combination of various blends. One of ordinary skill in the art can select the material for a high strength-to-weight ratio. In one embodiment, at least one surface of the attachment post 130 is coated, wherein the coating is operable to provide additional protection from the elements and from wear and tear. In one embodiment, the coating is a polymeric coating, including but not limited to resin-based coatings, acrylic-based coatings, and/or vinyl-based coatings, or a combination thereof. In one embodiment, the attachment post 130 is a unitary body. In one embodiment, the attachment post 130 is a fastener, including but not limited to rivets, screws, pins, and bolts.

In one embodiment, the front wall 128 includes a front magnet 150. In one embodiment, the front wall 128 includes a wall extending inwards towards the pocket 126, wherein the raised wall includes a front magnet 150. The front magnet 150 provides for a magnetized painting tool placed within, or adjacent to, the pocket to be held in place. In one embodiment, the front magnet 150 is comprised of a magnetic metal, such as, but not limited to, iron, nickel, cobalt, steel, rare earth elements, alnico alloys, and ferromagnetic alloys. In another embodiment, the front magnet 150 is an electromagnet that is able to connect to an external power supply (e.g., a DC current supply from a battery). In such an embodiment, an on-off switch is located on an exterior surface of the paint container 120 to turn the front magnet 150 on or off. In one embodiment, the front magnet 150 protrudes inwardly or outwardly from the front wall 128. In one embodiment, the front magnet 150 is completely embedded in the paint container 120, such that the front magnet 150 is not visible to an observer. In one embodiment, the base of the paint container 120 is comprised of a flexible material, wherein the paint container 120 is able to collapse onto itself for compact storage, wherein the front wall 128 is operable to attach to the opposite surface of the paint container 120 such that the paint container 120 remains in the collapsed state.

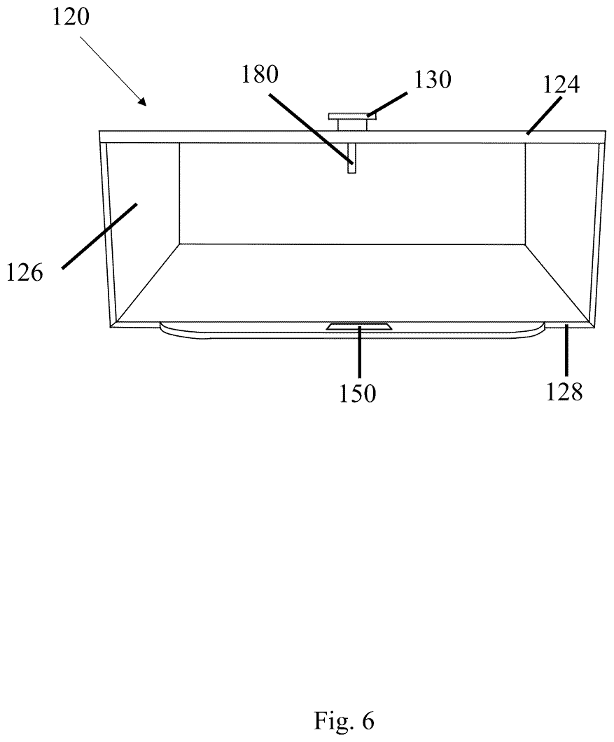

FIG. 6 illustrates a top view of a paint container according to another embodiment of the present invention. In one embodiment, the paint container 120 comprises a front magnet 150. The front magnet 150 provides for a magnetized painting tool placed within, or adjacent to, the pocket to be held in place. In one embodiment, the front magnet 150 is comprised of a magnetic metal, such as, but not limited to, iron, nickel, cobalt, steel, rare earth elements, alnico alloys, and ferromagnetic alloys. In another embodiment, the front magnet 150 is an electromagnet that is able to connect to an external power supply (e.g., a DC current supply from a battery). In such an embodiment, an on-off switch is located on an exterior surface of the paint container 120 to turn the front magnet 150 on or off. In one embodiment, the front magnet 150 protrudes inwardly or outwardly from the front wall 128. In one embodiment, the front magnet 150 is completely embedded in the paint container 120, such that the front magnet 150 is not visible to an observer.

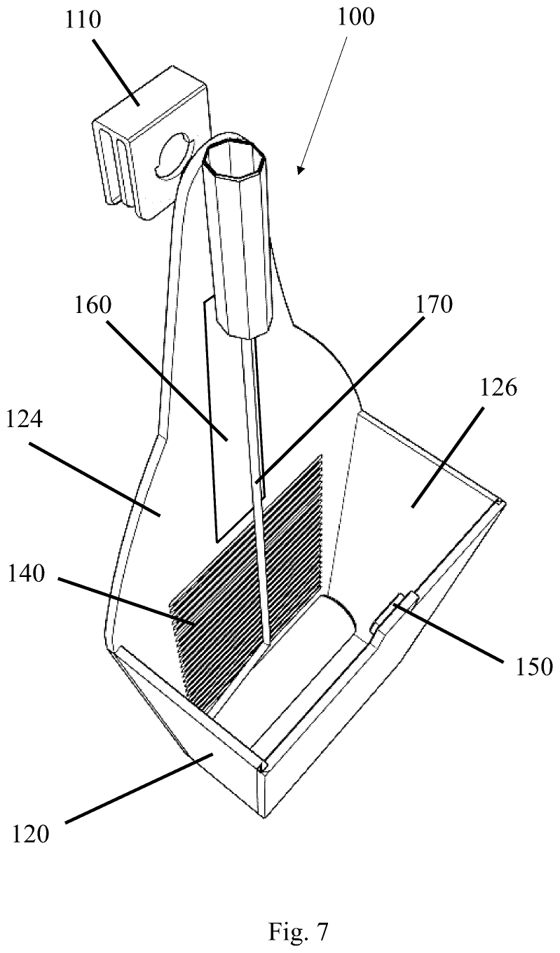

FIG. 7 illustrates a perspective top exploded view of the paint caddy with a paint roller. In one embodiment, the paint container 120 is operable to contain paint and a paint roller 170. One of ordinary skill in the art will appreciate the paint roller 170 is an exemplary embodiment of a hand-held painting tool, which includes but is not limited to brushes, rollers, and palette knives. In one embodiment, at least one dimension of the base of the paint container 120 is at least the size of the widest dimension of the head of the paint roller 170, wherein the paint roller 170 is operable to rest on the bottom of the paint container 120. In one embodiment, the bottom wall of the pocket 126 is substantially flat for the paint container 120 to rest upright on the ground without support. In one embodiment, the profile of the base of the paint container 120 is bigger than the profile of the paint roller 170, excluding the handle, to account for the large variety of hand-held painting tools on the market. In one embodiment, the paint container 120 is comprised of a liner, wherein the liner is disposable and provides for quick and easy cleanup.

In one embodiment, the back magnet 160 is operable to hold the paint roller 170 in place. In one embodiment, the back magnet is located on the interior face of the back wall 124, wherein the back magnet is centered in the top area of the paint container 120, wherein the top area is the region above the enclosure of the paint container 120 that is operable to hold paint. In one embodiment, the back magnet is located on the center axis of the back interior face 120. In one embodiment, the interior face of the back wall 124 of the paint container 120 is comprised of a magnetic material, wherein the back interior face 120 is operable to secure a paint roller 170 to the paint container 120. In one embodiment, the back magnet 160 is comprised of a magnetic metal, such as but not limited to iron, nickel, cobalt, steel, rare earth elements, alnico alloys, and ferromagnetic alloys. In another embodiment, the back magnet 160 is an electromagnet that would require an external power supply (e.g., a DC current supply from a battery). In such an embodiment, an on-off switch is located on an exterior surface of the paint container 120 to turn the back magnet on or off. In one embodiment, the back magnet 160 protrudes from the interior surface of the paint container 120. In one embodiment, the back magnet 160 is completely embedded in the paint container 120, wherein the back magnet 160 is not visible to an observer. In one embodiment, the back magnet 160 is operable to hold the paint roller 170 wherein the paint roller 170 does not touch the bottom of the paint container 120. In one embodiment, the paint container 120 does not comprise a back magnet 160.

In one embodiment, the clip 110 is attached to a painter's belt and the paint container 120 is attached to the clip 110, wherein the paint container 120 is operable to freely rotate about the clip 110. In one embodiment, the paint container 120 holds a volume of paint before attaching to the clip 110. In one embodiment, the paint container 120 is operable to be topped-off with additional paint as the user paints. In one embodiment, the paint container 120 is operable to be switched with a replacement paint container 120, wherein the replacement paint container 120 is comprised of additional paint. With a modular design, the paint caddy 100 allows for convenient swaps of paint colors or types, such that the user can quickly manage paint selection depending on the circumstances. In one embodiment, the paint roller 140 moves against the textured surface 140 to deposit excess paint collected on the paint roller 140 before application.

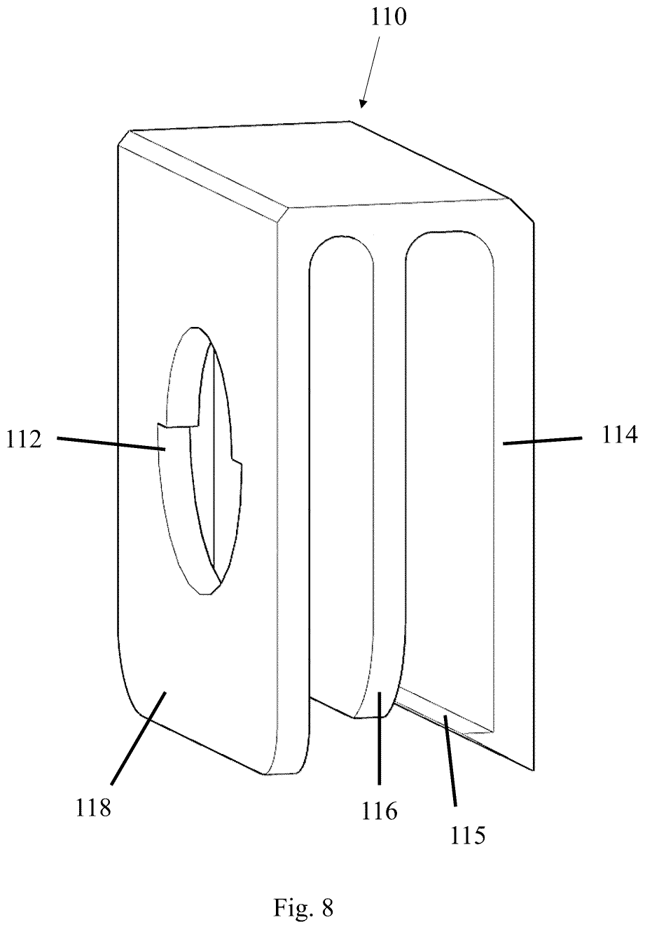

FIG. 8 illustrates a perspective side view of the clip. In one embodiment, the clip 110 is a three-pronged structure, wherein the first outer prong 114 terminates in a bend 115 to clip to a user's belt, wherein the second outer prong 118 includes an opening 112 as an attachment anchor for the paint container 120, and wherein the middle prong 116 is a divider, wherein the middle prong 116 provides additional support. In one embodiment, the clip 110 is designed to attach to a user's belt via friction. In one embodiment, the clip 110 is comprised of a flexible material wherein a prong is operable to flex, wherein the user's belt is held between two prongs, and wherein when a prong is flexed open, the clip 110 is operable to detach from the user's belt. In one embodiment, two prongs are connected via a snap-fit connection, providing a more secure mechanism for the clip 110 to stay attached to the user's belt. In one embodiment, the clip 110 is a two-pronged structure, wherein one prong 114 terminates in a bend 115 to clip to a user's belt, and wherein the other prong 118 comprises of an opening 112 as an attachment anchor for the paint container 120. In one embodiment, the clip 110 is textured to provide additional surface area to attach to a user's belt. In one embodiment, the outer prong 114 of the clip 110 is shaped to catch the material of the user's belt, wherein two prongs of the clip 110 hold the belt to secure the clip 110 in place. For example, two prongs of the clip 110 each include a segment that press against the other, wherein a prong can flex out to create a space to contain the belt. In one embodiment, the opening 112 corresponds to the cross-section of the attachment post, wherein the attachment post is operable to be secured and the paint container is operable to freely rotate around the attachment post. In one embodiment, the clip 110 is operable to hold up to about 5 pounds of weight. In one embodiment, the clip 110 is operable to hold up to about 10 pounds of weight. In one embodiment, the clip is operable to hold up to about 12 pounds of weight. In one embodiment, the clip is operable to hold up to about 15 pounds of weight. In one embodiment, the clip 110 is operable to hold up to about 50 pounds of weight.

In one embodiment, the clip 110 is comprised of one or more materials, including but not limited to one or more plastics, one or more metals, fiber reinforced composites, rubber, and/or fabrics. In one embodiment, the material used for the clip 110 is a flexible plastic material, such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, and any combination thereof. In one embodiment, the material used for the clip 110 is conducive for additive manufacturing, including but not limited to acrylonitrile butadiene styrene (ABS), polylactic acid (PLA), polyethylene terephthalate (PET), glycol-modified PET (PETG), nylon, stainless steel, and a combination of various blends. One of ordinary skill in the art can select the material for a high strength-to-weight ratio. In one embodiment, at least one surface of the clip 110 is coated, wherein the coating is operable to provide additional protection from the elements and from wear and tear. In one embodiment, the coating is a polymeric coating, including but not limited to resin-based coatings, acrylic-based coatings, and/or vinyl-based coatings, or a combination thereof. In one embodiment, the clip 110 is formed from additive manufacturing, including but not limited to fused deposition modeling (FDM), stereolithography (SLA), digital light processing (DLP), selective laser sintering (SLS), selective laser melting (SLM). Alternatively, the clip 110 is formed from a different manufacturing process, including but not limited to injection molding, casting, computer numerical control (CNC) machining, or a combination. In one embodiment, the clip 110 is formed from a combination of additive manufacturing techniques and subtractive manufacturing techniques.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A self-leveling paint caddy, comprising:
a container including a substantially flat back and a pocket;
a clip; and
an attachment post integrally formed with the container;
wherein the pocket extends from a bottom end of a front side of the substantially flat back, and wherein the pocket includes a top opening;
wherein an interior side wall of the pocket includes a textured surface;
wherein the pocket includes a magnetic element, and wherein the magnetic element is operable to hold a magnetized painting tool in place;
wherein the substantially flat back wall includes a hook; and
wherein the attachment post is configured to receive the clip, and wherein the container is operable to rotate about the clip.

2. The self-leveling paint caddy of claim 1, wherein the pocket is operable to hold about 1.5 quarts of paint.

3. The self-leveling paint caddy of claim 1, wherein the container is formed from additive manufacturing techniques.

4. The self-leveling paint caddy of claim 1, wherein the textured surface includes ridges integrally formed with the container.

5. The self-leveling paint caddy of claim 1, wherein the textured surface is created as a separate component, wherein the textured surface is operable to be attached to the container.

6. The self-leveling paint caddy of claim 5, wherein the textured surface includes a plurality of raised ridges.

7. The self-leveling paint caddy of claim 1, wherein the container further includes a disposable liner.

8. The self-leveling paint caddy of claim 1, wherein the clip is operable to hold about 12 pounds of weight.

9. A self-leveling paint caddy, comprising:
a container including a substantially flat back and a pocket;
a clip; and
an attachment post integrally formed with the container;
wherein the pocket extends from a bottom end of a front side of the substantially flat back, and wherein the pocket includes a top opening;
wherein a front wall of the pocket includes a top extension;
wherein the top extension includes a magnetic element, and wherein the magnetic element is not visible externally;
wherein the substantially flat back wall includes a hook;
wherein the attachment post is configured to receive the clip, and wherein the container is operable to rotate about the clip; and
wherein the clip includes three prongs, wherein one of the three prongs terminates in a bend.

10. The self-leveling paint caddy of claim 9, wherein the clip is formed from additive manufacturing techniques.

11. The self-leveling paint caddy of claim 9, wherein the hook is configured to hold a painting tool in a resting position.

12. The self-leveling paint caddy of claim 11, wherein the hook is operable to be switched out with a replacement hook, and wherein the replacement hook is a different size and/or shape from the hook.

13. The self-leveling paint caddy of claim 9, wherein at least one surface of the container is coated, wherein the coating is operable to prevent the paint from adhering to the at least one surface.

14. The self-leveling paint caddy of claim 9, wherein the top extension includes a plurality of recesses.

15. The self-leveling paint caddy of claim 14, wherein the plurality of recesses are evenly distributed across the top extension.

16. The self-leveling paint caddy of claim 9, wherein an outer prong of the clip includes an opening for the attachment post.

17. A system for automatic leveling paint storage, comprising:
a container and a clip;
wherein the container includes an attachment post;
wherein the clip is configured to attach to a belt and receives the container, wherein the container fastens to the clip via the attachment post;
wherein the clip includes an enclosed opening;
wherein the container is operable to rotate about the clip; and
wherein the clip is configured to receive a replacement container.

18. The system of claim 17, wherein the container is operable to hold about 1.5 quarts of paint.

19. The system of claim 17, wherein the clip includes three prongs, wherein one of the three prongs terminates in a bend.

20. The system of claim 17, wherein the container further includes a disposable liner.
